(19) United States
(12) Patent Application Publication
(10) Pub. No.: US 2002/0178948 A1
(43) Pub. Date: Dec. 5, 2002

(54) Method and apparatus for storing processed printing plates

(76) Inventors: Ian Platt, Watton (GB); Frans Hammersma, Stuston (GB)

Correspondence Address: HOFFMAN WARNICK & D'ALESSANDRO, LLC, 3 E-COMM SQUARE, ALBANY, NY, 12207

(21) Appl. No.: 09/848,018

(22) Filed: May 3, 2001

Related U.S. Application Data
(60) Provisional application No. 60/211,932, filed on Jun. 16, 2000.

(30) Foreign Application Priority Data
May 16, 2000 (EP) 00201726.7

(51) Int. Cl. B41F 1/00; B41L 47/14

(52) U.S. Cl. 101/477

(57) ABSTRACT

A method for storing printing plates (4) in a stacker (5) comprises the steps of detecting a printing plate (8) exiting a processor (1) or exiting a baking station, activating a conveying mechanism (2) of a stacker, conveying (A) the printing plate to a rear side (18) of the stacker and deactivating the conveying mechanism when the printing plate reaches the rear side of the stacker. Then further steps comprise tilting (B) the printing plate by means of rotating tilting bars (6) into a plate trolley (5) and returning the tilting bars back to a home position (19) on the stacker. Herein, the tilting the printing plate comprises the substeps of releasing a forcing means from the stacker, and forcing (P) the printing plate away from the tilting bars against a rest position (21) in the trolley.

### FIELD OF THE INVENTION

The present invention relates to a method and an apparatus for storing printing plates in a stacker. More specifically, the invention is related to an improved method and apparatus for automatically storing processed and/or baked lithographic offset printing plates.

### BACKGROUND OF THE INVENTION

In U.S. Pat. No. 5,455,651 and in U.S. Pat. No. 5,606,720 (both assigned to Agfa-Gevaert N. V.) there are illustrated apparatus for processing exposed photographic sheet material, in particular lithographic printing plates, of the type described in EP-A-410500 (of Agfa-Gevaert N. V.) .

At the output side of the processor a LITHOSTAR™ plate stacker LS82 Ultra may be installed , which is a printing plate reception tool making it possible to collect more than one printing plate without risk of damages such as scratches or any other visible traces left on the printing plate. Yet, large format plates, especially thin plates (e.g. with a thickness of 0.15 mm) have caused stacking problems on the transport trolley: they can buckle out (see FIG. 3; to be discussed in the detailed description), drop down of the trolley and become damaged.

### OBJECTS OF THE INVENTION

It is an object of the present invention to provide a solution to the above problem.

Other objects and advantages of the present invention will become clear from the detailed description.

### SUMMARY OF THE INVENTION

The above mentioned objects are realised by a method having the specific features defined in claim 1.

Specific features for preferred embodiments of the invention are set out in the dependent claims.

### BRIEF DESCRIPTION OF THE DRAWINGS

The invention will be described by the following illustrative embodiments with reference to the accompanying drawings, which are not necessarily to scale, without the intention to limit the invention thereto, and in which:

FIGS. 1 and 2 show principle front views of a plate stacker with a transport trolley according to prior art;

FIG. 3 shows a stacking problem occurring in prior art;

FIGS. 4.1 and 4.2 respectively show a top view and a front view of a preferred embodiment according to the present invention, illustrating a pushing finger in home position;

FIG. 5 shows a schematical front view of a preferred embodiment according to the present invention, comprising a tilting bar of the plate stacker in an upright position and the pushing finger to a maximum push position;

FIGS. 6.1 to 6.3 show schematical views of a tilting mechanism in home position according to the present invention, respectively a front view, a top view and a side view;

FIGS. 7.1 to 7.3 shows practical views of a tilting mechanism in a maximum push position according to the present invention, respectively a front view, a top view and a side view;

FIG. 8 gives a frontal overview of a stacking system for printing plates suitable for use with the present invention.

FIG. 9 shows a global side view of a preferred embodiment according to the present invention;

FIG. 10 shows a partial front view of a preferred embodiment according to the present invention, comprising a tilting bar of the plate stacker in its end position and a pushing finger to a maximum push position.

### DETAILED DESCRIPTION OF THE INVENTION

While the present invention will hereinafter be described in connection with preferred embodiments thereof, it will be understood that it is not intended to limit the invention to those embodiments.

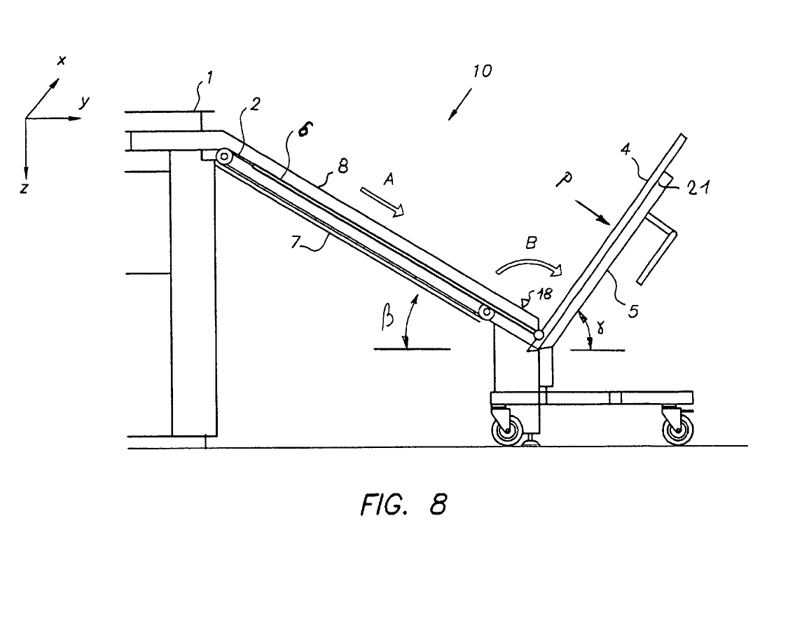

First a general description can be given in relation to FIG. 8 illustrating an overview of a stacking system for printing plates suitable for use with the present invention. Herein a stacker 10 is installed between the exit of a plate processor 1 and a trolley 5. The inclination β of the stacker can be adapted (by means of lifting arm 3) in order to get a good handling of the printing plate from the processor, over the stacker to the trolley (having an inclination γ) . The stacker 10 mainly comprises a set of printing plate conveying strings (or belts) 2 and a set of printing plate tilting bars 6. Arrow A indicates a printing plate conveying operation, whereas arrow B indicates a printing plate tilting operation. Reference nr 4 indicates collected printing plates on stacker 5. For sake of good understanding, it is mentioned in advance that in the present specification, a view along the X-direction is called a ‘front view’, a view along the Y-direction is called a ‘side view’, and a view along the Z-direction is called a ‘top view’.

Now, the solution of the present invention will be discussed thoroughly, step by step, in reference to FIGS. 1 to 10.

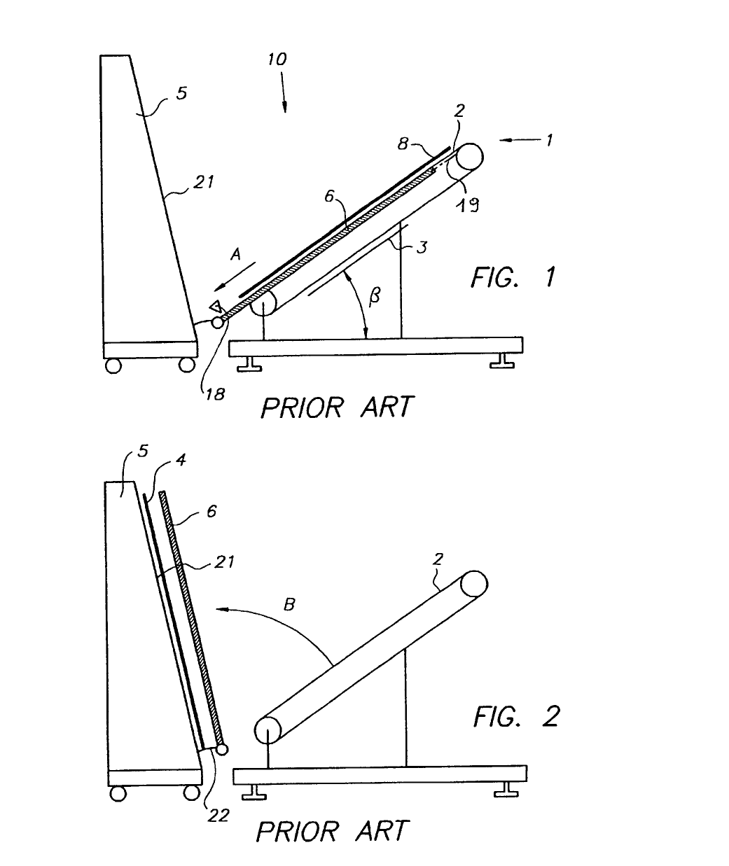

FIGS. 1 and 2 show two principle front views of a plate stacker 10 with a transport trolley 5 according to the prior art and incorporated by e.g. LITHOSTAR™ plate stackers LS82 or LS150 (both of Agfa-Gevaert).

In FIG. 1 a set of tilting bars 6 (e.g. a set of 10 tilting bars, preferably all in one plane) is in a home position 19 underneath a set of conveying strings 2. A processed printing plate 8 is coming down (see arrow A) to a rear side 18 of the stacker 10.

In FIG. 2 tilting bars 6 tilt printing plate 8 onto plate trolley 5.

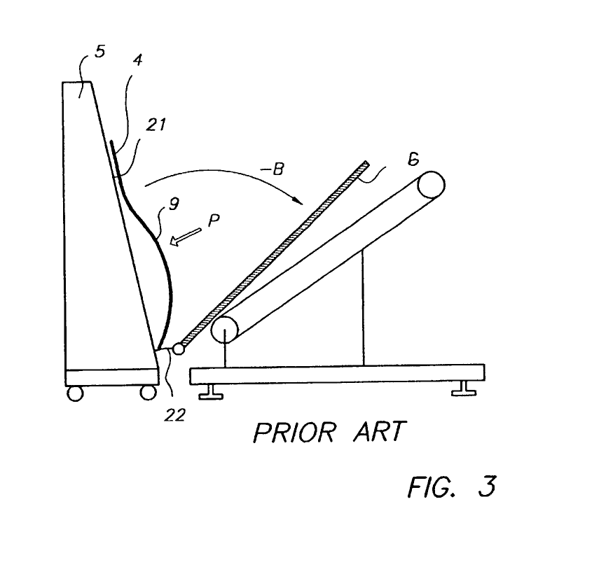

FIG. 3 illustrates a problem in the prior art wherein a printing plate 4, especially a large and thin printing plate 4 can buckle up (see mark 9) and drop down the trolley 5. So, sometimes, said fallen printing plates can get damaged. This causes a lot of trouble as e.g. distortion of the work flow, loss of quality, possibly loss of printing plate material, extra manipulation and cost.

The further description discloses the characterising steps of the instant invention, wherein tilting the printing plate 8 is carried out by (i) releasing a pushing means from said stacker, and (ii) pushing said printing plate away from said tilting bars against a rest position in said trolley. Hereto, the inventors have developed an inventive pushing finger mechanism.

In a first embodiment of the present invention, a method for storing printing plates (4) in a stacker (5), comprises the steps of:

detecting a printing plate (8) exiting a processor (1) or exiting a baking station,

activating a conveying mechanism (2) of a stacker,

conveying (A) said printing plate to a rear side (18) of said stacker,

deactivating said conveying mechanism when said printing plate reaches said rear side of said stacker,

tilting (B) said printing plate by means of rotating tilting bars (3) into a plate trolley (5),

returning said tilting bars back to a home position (19) on said stacker,

wherein said tilting said printing plate comprises following substeps:

releasing a forcing means from said stacker, and

forcing (P) said printing plate away from said tilting bars against a rest position (21) in said trolley.

From another point of view, the present invention also provides a stacker for storing processed printing plates making use of a method as described hereabove.

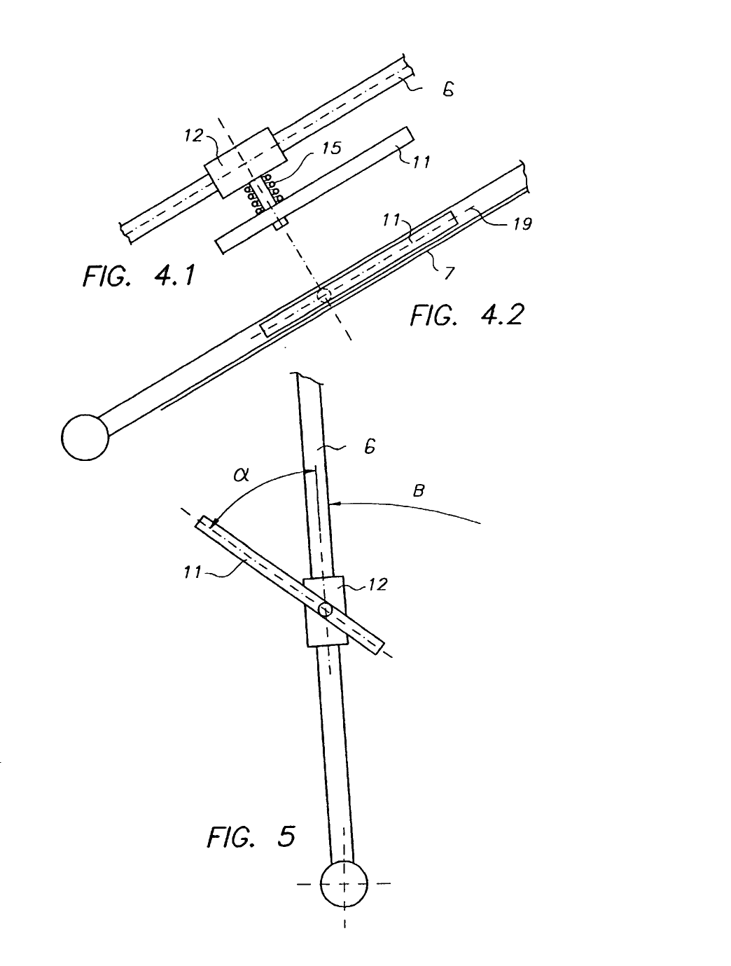

FIGS. 4.1 and 4.2 respectively show a top view and a front view of a preferred embodiment according to the present invention, comprising a pushing means, preferably a pushing finger or a plate assisting lever 11 in home position 19. When the tilting bars are in home position, the push finger is in line, or at least parallel, with the tilting bars, laying against the cover 7 of the plate stacker.

FIG. 5 shows a schematical front view of a preferred embodiment according to the present invention, comprising a tilting bar of the plate stacker in an intermediate position, e.g. an upright position and the pushing finger to a maximum push position. As can be seen in FIG. 5, after a printing plate has reached a sensor (e.g. a microswitch, a dielectric or an optic or a ultrasonic or a pneumatic sensor; not shown) at the bottom 18 of the plate stacker, the tilting bars 6 moves upwards and brings the printing plate in position against the transport trolley. A pushing finger 11 will be pushed out as soon as the tilting bars have moved away from the cover 7 of the plate stacker. This will support the printing plate until it has reached its final position 21 on the transport trolley 5 and will prevent the printing plate distorting and sliding downwards. From the above, it can be repeated that in a further preferred embodiment of the present invention said releasing a forcing means comprises releasing a pushing means, and said forcing said printing plate comprises pushing said printing plate against a rest position (21) in said trolley.

In a further preferred embodiment said releasing a pushing means comprises rotating a pushing finger over a predetermined angle α.

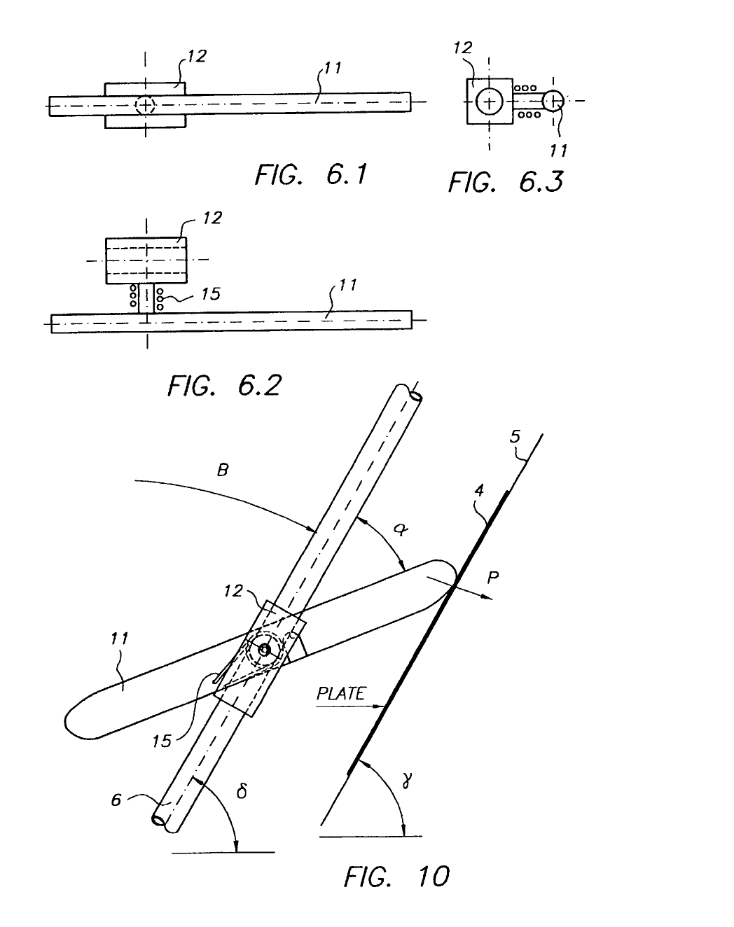

Preferably said predetermined angle α is between 15 and 45 degrees, and more preferably being about 30 degrees. Now in relation to FIGS. 6.1-6.3, 7.1-7.3 and 10, it will be explained that in a further preferred embodiment said pushing said printing plate against a rest position in said trolley is carried out under a predetermined spring-load. Preferably, said predetermined spring-load is in a range between 300 and 700 N.mm, more preferably between 400 and 600 N.mm, and most preferably between 475 and 525 N.mm .

FIG. 10 shows a partial front view of a preferred embodiment according to the present invention, comprising a tilting bar of the plate stacker in its end position and a pushing finger to a maximum push position.

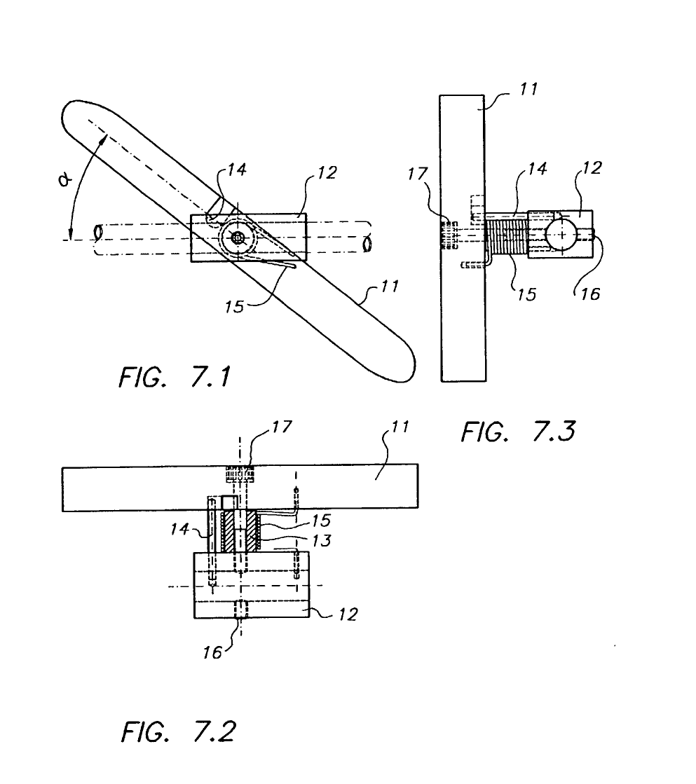

FIGS. 6.1 to 6.3 show schematical views of a tilting mechanism according to the present invention, respectively a front view, a top view and a side view. FIGS. 7.1 to 7.3 shows practical views of a tilting mechanism according to the present invention, respectively a front view, a top view and a side view. Herein, following reference nrs are used 11 is a plate assisting lever, 12 a plate assisting block, 13 a plate assisting spacer, 14 a stop pin, 15 a torsion spring, 16 a first screw and 17 a second (fastening) screw.

The pushing finger mechanism consists of e.g. five individual components fitted with a spring 15 that gives the pushing finger its rotation in a range between 15 and 45°, preferably approximately 30°. The pushing finger can be positioned at different heights and slides over the tilting bars of the plate stacker 10. In some cases it may be necessary to fit more than one pushing finger on a same tilting bar.

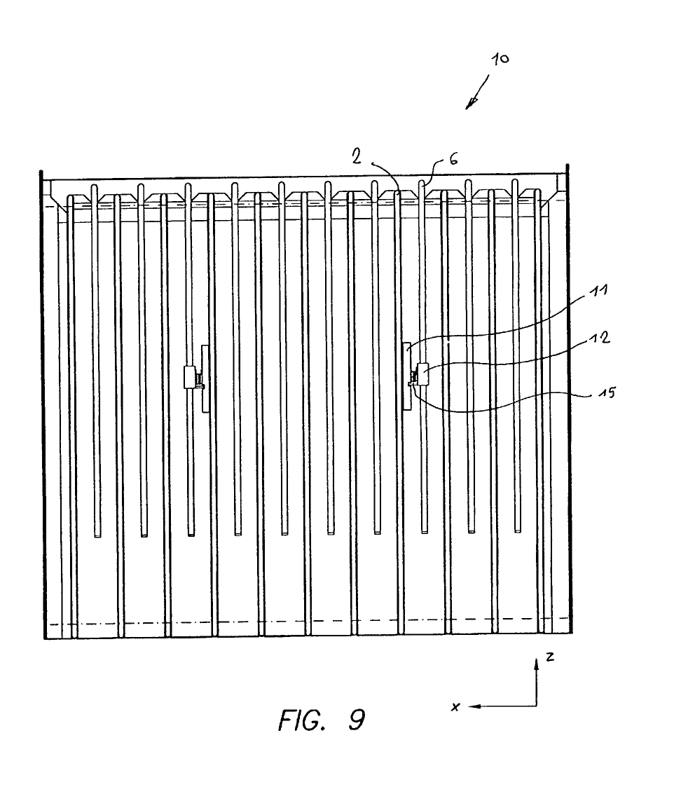

FIG. 9 shows a global side view of a preferred embodiment according to the present invention. In stacker 10, one perceives a set of conveying strings or belts 2, a set of tilting bars 6, two plate assisting levers 11, two plate assisting blocks 12 and two torsion spring 15.

In a further preferred embodiment of a stacker according to the present invention, said pushing means comprises at least one pushing finger. Other embodiments of such pushing means comprise e.g. an elastomer of suitable elasticity and friction, air pressure means comprising an air jet with overpressure or/and a suction by underpressure, electromagnetic means, etc.

In a still further preferred embodiment said at least one pushing finger is positioned laterally slidably over a tilting bar.

For people in the art it may be clear that still many other embodiments are enclosed within the scope of the present invention. Amongst others, the direction of transporting the printing plate may be as well from the right to the left as vice versa (cf. FIGS. 1-3 versus FIGS. 8 & 10), the plate assisting lever 11 may be mounted on the left of the plate assisting block 12 or it may be mounted on the right side (see FIG. 9), the torsion spring 15 may be oriented to the left or may it be oriented to the right (implicitly indicated in FIG. 9), both parts of plate assisting lever 11 may have an unequal length or unequal length (cf. FIGS. 4-6, versus FIGS. 7, 9, 10), etc. Moreover, plate assisting lever 11 may have a linear axis of symmetry (as shown e.g. in FIGS. 4.2, 5, 6.1, 6.2, 7.1), an inclined linear or hooked axis of symmetry, or a curvilinear axis of symmetry (e.g. a boomerang-type). Further, torsion spring 15 may be replaced by a suitable compression spring, an extension spring, a leaf spring, etc.

### APPLICABILITY OF THE INVENTION

The instant invention comprises an add-on feature that can be fitted to existing plate stackers, for example on a “Druck Platten Stapler PSH 85, PSH 105, PSH125 or PSH 145” (available from Agfa-Gevaert).

The instant invention is particularly advantageous when used in relation to large format plates. For example, plates up to 820 mm×1130 mm may be processed in a ‘Galileo-system’ (available from Agfa-Gevaert).

As mentioned before, lithographic printing plates according to e.g. EP-A-410500 may be used in the present invention. EP-A-410500 disclosed an imaging element containing an aluminium support provided with in the order given an image receiving layer and a silver halide emulsion. In the document there is disclosed a diffusion transfer reversal process (hereinafter called “DTR process”) for obtaining a lithographic printing plate in which said imaging element is imagewise exposed and subsequently developed using a developing liquid or activating liquid in the presence of a silver halide complexing agent. The imaging element is then guided through a diffusion transfer zone so that the silver halide complexes formed during the development step are allowed to diffuse into the image receiving layer where they are converted to silver. When the imaging element leaves the diffusion transfer zone a silver image is formed in the image receiving layer. The now useless photosensitive layer and optional other layers above the image receiving layer are then removed by guiding the imaging element through a washing and through a rinsing station. Finally the element now carrying a silver image on its surface is treated with a finishing liquid that contains a so called hydrophobizing agent for improving the hydrophobicity of the silver image.

Further, the instant invention may be applied as well on silver-halogenid-printing plates, as on so-called thermal printing plates, as on polymer printing plates, as on direct thermal plates. Suitable supports comprise aluminium, which was explicitly mentioned before; but also polyester or paper supports (cf. SETPRINT™) might be applied.

Moreover, the instant invention also can be applied on plates exiting a baking station (not shown), or even on unprocessed printing plates disposed from a loading system (e.g. for sake of collecting). An example of such a baking station comprises a burn-in oven “Haase TOP Line 2000” of Peter Haase GmbH.

Having described in detail preferred embodiments of the current invention, it will now be apparent to those skilled in the art that numerous modifications can be made therein without departing from the scope of the invention as defined in the appending claims.

| | |
|---|---|
| Parts list: | |
| 1 | plate processor |
| 2 | conveying strings |
| 3 | lifting arm |
| 4 | collected printing plates |
| 5 | trolley |
| 6 | tilting bars |
| 7 | cover of the stacker |
| 8 | processed printing plate |
| 9 | buckle |
| 10 | stacker |
| 11 | pushing finger or plate assisting lever |
| 12 | plate assisting block |
| 13 | plate assisting spacer |
| 14 | stop pin |
| 15 | torsion spring |
| 16 | first screw |
| 17 | second (fastening) screw. |
| 18 | rear side (bottom) of stacker |
| 19 | home position of tilting bars in stacker |
| 21 | rest position of collected plates in trolley |
| 22 | bottom of the trolley |
| Symbols: | |
| A | conveying plate in stacker |
| B | tilting plate into trolley |
| −B | returning tilting bars towards stacker |
| P | pushing force |
| X, Y, Z | tridimensional co-ordinates, respectively indicating |
| | a front direction, a side direction and a top direction |
| α | pressure angel of pushing finger |
| β | inclination of stacker |
| γ | inclination of trolley |
| δ | inclination of tilting bars |

1. A method for storing printing plates in a stacker, comprising the steps of:
detecting a printing plate exiting a processor or exiting a baking station,
activating a conveying mechanism of a stacker,
conveying said printing plate to a rear side of said stacker,
deactivating said conveying mechanism when said printing plate reaches said rear side of said-stacker,
tilting said printing plate by means of rotating tilting bars into a plate trolley,
returning said tilting bars back to a home position on said stacker,
wherein said tilting said printing plate comprises following substeps:
releasing a forcing means from said stacker, and
forcing said printing plate away from said tilting bars against a rest position in said trolley.

2. A method according to claims 1, wherein said releasing a forcing means comprises releasing a pushing means, and wherein said forcing said printing plate comprises pushing said printing plate against a rest position in said trolley.

3. A method according to claim 2, wherein said releasing a pushing means comprises rotating a pushing finger over a predetermined angle α.

4. A method according to claim 3, wherein said predetermined angle α is between 15 and 45 degrees, and more preferably being about 30 degrees.

5. A method according to claim 2, wherein said pushing said printing plate against a rest position in said trolley is carried out under a predetermined spring-load.

6. A method according to claim 5, wherein said predetermined spring-load is in a range between 300 and 700 N.mm, more preferably between and 600 N.mm, and most preferably between 475 and 525 N.mm .

7. A stacker for storing processed printing plates making use of a method according to claim 1.

8. A stacker according to claim 7, wherein said pushing means comprises at least one pushing finger.

9. A stacker according to claim 8, wherein said at least one pushing finger is positioned laterally slidably over a tilting bar.
